(19) United States
(12) Patent Application Publication
(10) Pub. No.: US 2011/0083382 A1
(43) Pub. Date: Apr. 14, 2011

(54) BUCK MEMBER

(76) Inventor: David Leroy Sanders, Basin, WY (US)

(21) Appl. No.: 12/577,601

(22) Filed: Oct. 12, 2009

(51) Int. Cl. E04G 15/02; E04G 21/00; E06B 1/04; E06B 1/56

(52) U.S. Cl. 52/215; 52/741.41

(57) ABSTRACT

A buck member for enclosing a flanged frame in an insulated concrete form structure for providing additional insulation in insulated concrete form structures is described. A method for using the same is disclosed.

### FIELD OF THE INVENTION

This invention relates to a buck member for insulating areas surrounding an opening in an insulated concrete form structure.

### BACKGROUND OF THE INVENTION

Insulated concrete form building structures, homes and other residential and commercial buildings, have benefits over conventionally built homes. The Lego™-like, building block nature of insulated concrete forms makes it easier to construct such buildings.

Insulated concrete form structures have superior thermal insulation properties, or R-values, relative to conventional wood houses. As a result of such superior insulating properties, these structures stay cooler in the summer months and warmer in the winter months. Insulated concrete form structures typically reduce heating, ventilation, and air conditioning costs by as much as 30 to 70%.

Additionally, the acoustic insulation properties of insulated concrete form building structures are superior to that of conventional wood housing. Also, these structures are generally more fire resistant and therefore safer and cost less to insure than conventional housing. In general, the structural integrity of insulated concrete form building structures results in higher resale values, higher insect resistance than wood construction, and greater resistance to wetness causing rot, which is commonly associated with wood structures.

Most insulated concrete structures are made from foam insulation building block forms comprising expanded polystyrene or extruded polystyrene material. Such structures are typically comprised of hollow blocks that are locked or fastened together. During construction of insulated concrete form structures, interlocking form units are stacked and connected to each other, thereby forming the desired structure's walls and shape. Concrete is pumped into the cavities of the hollow forms. Reinforced steel or rebar may be added before concrete pour to provide extra strength to the hardened concrete in the walls.

As insulated concrete forms are placed in position to create the overall structure, portions of these forms must be cut out for window and door frames in the desired locations of windows and doors and other openings. The insulated concrete form structures are then framed with conventional 2×4 and 2×6 lumber (buck members) such that liquid concrete will not flow out during the pour process, and for ease of attachment of the wood frames to a flange of a flanged window frame, with the result that wood, with its relatively low R-value, comprises a portion of the insulated concrete form structure. Thus, while the majority of the structure is constructed of insulated concrete forms, areas surrounding windows remain poorly insulated. Therefore, heating and cooling in the area near windows remains similar to conventional housing, while the remainder of the house benefits from the insulated concrete forms. Consequently, there exists a need to improve the technology associated with window frames in insulated concrete form structures.

### SUMMARY OF THE INVENTION

One object of the present invention is to provide a means of providing additional insulation in the area around an opening in an insulated concrete form structure.

In one embodiment, the present invention includes a buck member for attaching a flanged frame to an opening in a structure comprising insulated concrete form blocks, the buck member including a plate having a first end, a second end, a length, a width, a first surface facing the insulated concrete form blocks of the structure and a second surface opposite therefrom. The plate also having a first flange portion disposed perpendicular to the first end of the plate and adapted for attachment to the flange of the flanged frame, and a second flange portion disposed perpendicular to the second end of the plate in the opposite direction to the first flange portion and adapted for attachment to the insulated concrete form blocks.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The invention can be best understood by those having ordinary skill in the art by reference to the following detailed description when considered in conjunction with the accompanying drawings in which:

FIG. 1A illustrates a perspective view of one embodiment of the buck member.

FIG. 1B illustrates a perspective view of an embodiment of the buck member having triangular shaped indents.

FIG. 1C illustrates a perspective view of an embodiment of the buck member having triangular-shaped indents and attachment members across the indents.

FIG. 1D illustrates a perspective view of an embodiment of the buck member having oval or semicircle-shaped indents.

FIG. 2 illustrates a top view of a cross-section of two vertical buck members having triangular indents attached to the flange of a flanged frame, one side of each buck member being in contact with concrete poured into insulated concrete form structures while the opposing side is shown covered with insulation.

FIG. 3 illustrates a perspective view of attached vertical and a horizontal buck members attached to the flange of a flanged frame.

FIG. 4 illustrates a perspective view of another embodiment of the buck member, wherein the triangular indents are shown extending beyond the ends of the plate.

### DETAILED DESCRIPTION OF THE INVENTION

Reference will now be made in detail to embodiments of the invention, examples of which are illustrated in the accompanying drawings. Throughout the following, the same reference characters refer to the same or similar elements in all figures.

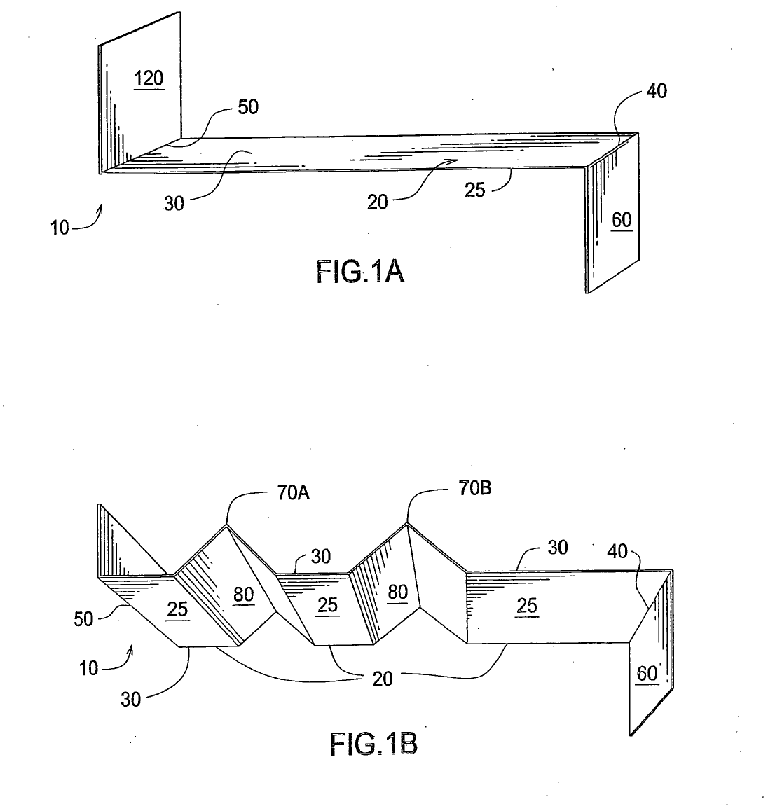

FIG. 1A is a perspective view of an embodiment of buck member 10 for use in insulated concrete form building structures. The buck member may be used with and is adapted to receive flanged frame windows, doors, and other flanged frame members placed into an insulated concrete form building structure. The buck member includes plate 20, having a first surface 30, a first end 40 and an opposing second end 50. The buck member further includes a first flange portion 60 adapted for attachment to the flange of a flanged frame disposed and extending in a direction perpendicular to the plate at first end 40. The buck member 10 has a second flange portion 120 adapted for attachment to the insulated concrete form blocks disposed and extending in a direction perpendicular to the plate at second end 50.

In one embodiment of the present invention, the first flange portion and the second flange portion are integrally formed with the plate. In another embodiment of the present invention the first and second portions are attached to the plate.

In another embodiment of the present invention, the plate has an at least one indent formed thereon. The at least one indent protrudes to and in the direction of the second flange portion and the at least one indent has a first surface and a second surface corresponding to the first and second surface of the plate.

FIG. 1B depicts two triangular indents, 70A and 70B formed in plate 20 each having interior surface 80 contiguous with the second surface 25 of plate 20 for providing structural strength to the plate.

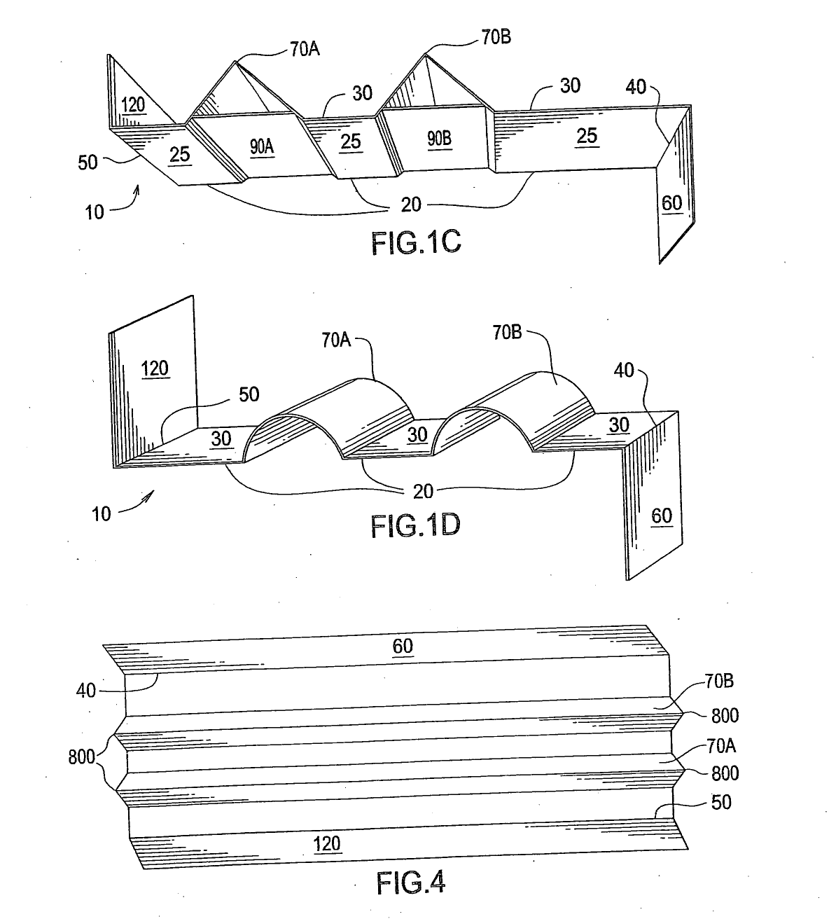

FIG. 1C depicts another embodiment of the buck member, wherein each indent 70A and 70B further includes attachment members 90A and 90B across the interior surface 80 of the indents 70A and 70B, respectively. The attachment members are oriented parallel to the non-indented portion of the plate. The attachment members provide a surface for receiving a metal screw, or other means of attachment known in the art, in order to secure, attach, anchor or fasten insulating material and/or finishing material to the plate, as will be shown in FIG. 2 hereof. Attachment members may be welded or otherwise attached to surface 80 of indents 70A and 70B.

FIG. 1D depicts another embodiment of the current invention, wherein the one or more indents comprise two semi-circles 70A and 70B. Many other indent shapes are contemplated by the disclosed invention, including, but not limited to, a three-sided rectangle, a three-sided square, or a semi-oval. This list of indent shapes is non-exhaustive, and any indent shape is clearly contemplated.

FIG. 2 depicts a cross-sectional top view of two buck members 10 attached to a flanged frame 110 between. This figure further illustrates the placement of the buck members relative to the insulated concrete form blocks 210 comprising walls in the concrete form structure. Not shown in FIG. 2 are the top or the bottom of the buck members, or the bottom or top insulated concrete form blocks.

FIG. 2 also depicts portion 220 of the frame flange 110 contacting the first flange portion 60 of buck member 10. This figure also depicts two insulation sheets 230 attached to the plate 20, typically contacting its second surface 25. This insulation sheet provides greater R-values than the conventional wood buck members currently used in insulated concrete form structures. The insulation sheet contacts the first flange portion 60 and the mounting plate 20. Finishing material 100, for example, sheet rock, may be attached to the insulation sheet 230. The insulation sheet 230 may be securely attached to the plate 20 of the buck member using metal screws 95 placed into attachment members 90A and 90B of the indents 70A and 70B, respectively. Many forms of attachment are contemplated in this invention and such forms are well known in the art, including, but not limited to, various adhesives, nails, and screws. Additionally, caulking 160, or other similar material, is placed around the flanged frame 110 and the finishing material 100.

FIG. 2 also shows attachment between the second flange portion 120 and the insulated concrete form block 210 on the inside of the insulated concrete form structure. Also depicted is outer material 140 that would typically cover the outside surface of the insulated concrete form blocks 210.

FIG. 2 depicts spaces between the following elements: the first flange portion 60 and the flanged frame 220; the first surface 30 of the plate and the insulated concrete form blocks 210; the second surface 25 of the plate and the insulation sheet 230; the second flange portion 120 and the insulated concrete blocks 210; the first flange portion 60 and the insulation sheet 230; the second flange portion and the finishing material 100; and, the insulation sheet 230 and the finishing material 100. These spaces are shown in FIG. 2 to more easily demonstrate the individual elements. In many embodiments of the invention as practiced, there are no such spaces between the elements, which are in extensive contact with one another.

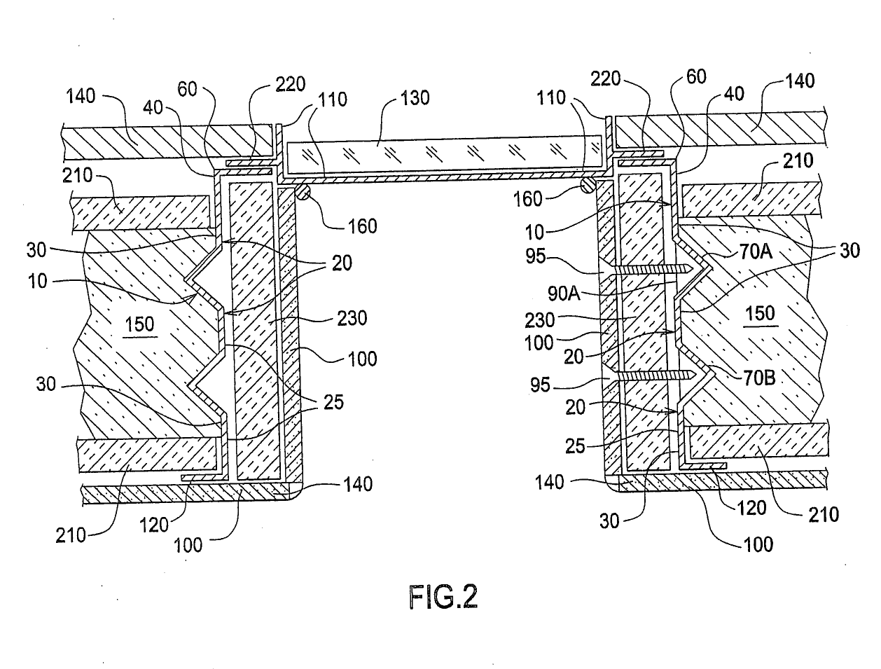

FIG. 3 depicts attachment of the flange portion 220 of flanged frame 110 to the first flange portion 60 via metal screws 170. The flanged frame 110 contains a window 130. Additionally, FIG. 3 depicts a cutaway portion of the frame flange to illustrate connection of two buck members using metal screw 180. Two bucks can also be attached using metal angles 190 and metal screws 200.

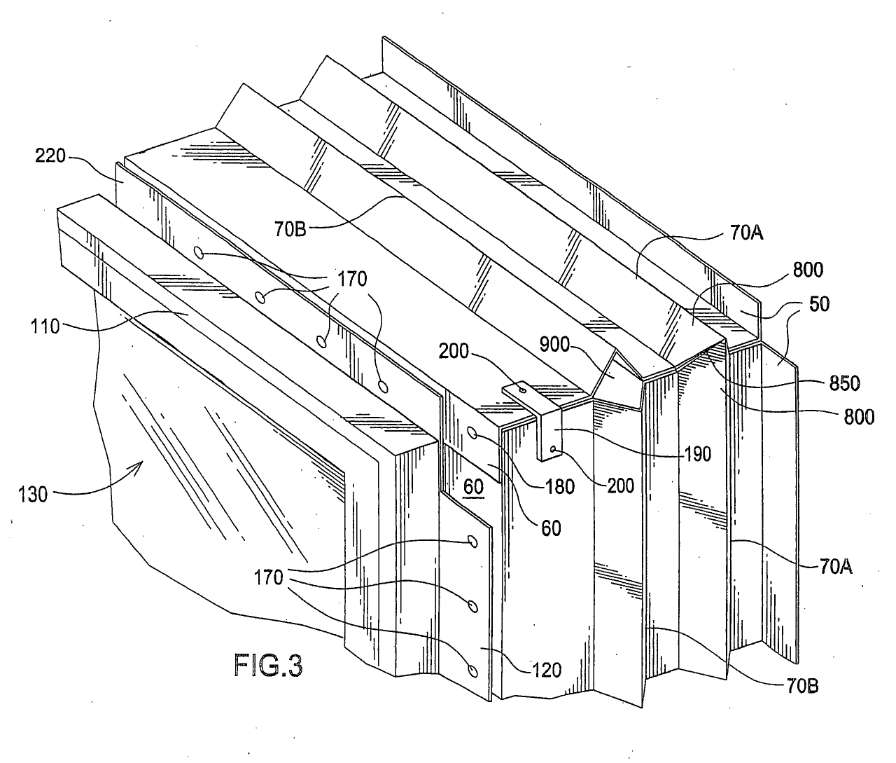

In another embodiment of the present invention, the at least one indent further comprises an at least one extended portion. FIG. 4 illustrates the at least one extended portions 800 from indents 70A and 7 B. The at least one extended portions permit flush attachment of two buck members such that the liquid concrete remains in the internal cavity space of the insulated concrete form blocks. The at least one extended portions are mitered at 45°, permitting two adjoining indents of two buck members to form a closed joint 850 shown in FIG. 3 hereof, as opposed to an opening 900, also shown in FIG. 3. Other angles are contemplated when the buck members of the present invention are used for other than rectangular frames. Additional embodiments of this invention contemplate the use of duct tape or other sealing methods to seal any space 900 between two buck members.

Additionally, the invention as contemplated herein can accommodate flanged frames of any polygonal or partial polygonal shape. It is also clearly contemplated within the scope of this invention that buck members may be made in all types of geometries including, but not limited to arches, circles, semicircles, triangles, etc. Furthermore, it is contemplated to be within the scope of the invention that the flanged frame, which attaches to one or more buck members is adapted to receive a variety of different windows.

The present buck member may be made of galvanized steel. However, other materials may be used depending on the particular use intended, including, but not limited to aluminum, other steels, plastics, and the like.

Also contemplated in the present invention is a method for insulating an area around an opening in an structure comprised of insulated concrete form blocks, said method comprising: A) generating an opening in the insulated concrete form structure; B) setting a buck in the opening, said buck member comprising: a plate having a first end, a second end, a length, a width, a first surface facing the insulated concrete form blocks, and a second surface opposing the first surface; having a first flange portion disposed perpendicular to the first end of said plate and adapted for attachment to the flange of a flanged frame member; and having a second flange portion disposed perpendicular to the second end of said plate in the opposite direction of the first flange portion, the second flange portion being adapted for attachment to the insulated concrete form blocks; C) attaching the frame flange to the first flange portion; and D) attaching an insulation sheet to the second surface of the plate. The present method further comprises pouring concrete into the concrete form blocks of the structure.

It is believed that the apparatus of the present invention, and many of its attendant advantages will be understood by the foregoing description. It is also believed that it will be apparent that various changes may be made in the form, construction, and arrangement of the components thereof without departing from the scope and spirit of the invention or without sacrificing all of its material advantages. It is the intention of the following claims to encompass and include such changes.

What is claimed is:

1. A buck member for attaching a flanged frame to an opening in a structure comprising insulated concrete form blocks, said buck member comprising:
a plate having a first end, a second end, a length, a width, a first surface facing the insulated concrete form blocks and a second surface opposite therefrom; having a first flange portion disposed perpendicular to the first end of said plate and adapted for attachment to the frame flange; and having a second flange portion disposed perpendicular to the second end of said plate in the opposite direction of the first flange portion, said second flange portion adapted for attachment to the insulated concrete form blocks.

2. The buck member of claim 1, wherein the first flange portion and the second flange portion are integrally formed with said plate.

3. The buck member of claim 1, wherein the first and the second flange portions are attached to said plate.

4. The buck member of claim 1, wherein said plate has an at least one indent formed thereon, the at least one indent protruding parallel to and in the direction of the second flange portion and the at least one indent having a first surface and a second surface corresponding to the first and second surface of the plate.

5. The buck member of claim 4, wherein the at least one indent further comprises a an attachment member across the inner surface of the of the at least one indent, said attachment member disposed parallel to the plate.

6. The buck member of claim 4, wherein the at least one indent further comprises an at least one extended portion.

7. The buck member of claim 1, further comprising an insulation sheet attached to the second surface of said plate.

8. The buck member of claim 1, wherein said flanged frame is adapted to receive a window.

9. The buck member of claim 1, wherein said flanged frame is adapted to receive a door.

10. A method for insulating an area around an opening in an structure comprised of insulated concrete form blocks, said method comprising:
generating out the opening in the insulated concrete form structure;
setting one or more buck member in the opening, said buck member comprising: a plate having a first end, a second end, a length, a width, a first surface facing the insulated concrete form blocks and a second surface opposite therefrom; having a first flange portion disposed perpendicular to the first end of said plate and adapted for attachment to the frame flange; and having a second flange portion disposed perpendicular to the second end of said plate in the opposite direction of the first flange portion and said second flange portion adapted for attachment to the insulated concrete form blocks;
attaching the frame flange to the first flange portion; and
attaching an insulation sheet to the second surface of the plate.

11. The method of claim 10, wherein the method further comprises pouring concrete into the concrete form blocks of the structure.

12. The method of claim 10, wherein the first flange portion and the second flange portion are integrally formed with said plate.

13. The method of claim 10, wherein the first and the second flange portions are attached to said plate.

14. The method of claim 10, wherein said plate has an at least one indent formed thereon, the at least one indent protruding parallel to and in the direction of the second flange portion and the at least one indent having a first surface and a second surface corresponding to the first and second surface of the plate.

15. The method of claim 14, wherein the at least one indent further comprises an attachment member across the inner surface of the of the at least one indent, said attachment member disposed parallel to the plate.

16. The method of claim 14, wherein the at least one indent further comprises an at least one extended portion.

17. The method of claim 10, wherein said flanged frame is adapted to receive a window.

18. The method of claim 10, wherein said flanged frame is adapted to receive a door.
